(19) United States
(12) Patent Application Publication
(10) Pub. No.: US 2018/0209511 A1
(43) Pub. Date: Jul. 26, 2018

(54) End Fitting and Ratchet Turnbuckle

(71) Applicant: Marathon Petroleum Company LP, Findlay, OH (US)

(72) Inventors: Christopher S. Stephens, Lavalette, WV (US); Shawn McClaskey, Ironton, OH (US)

(73) Assignee: Marathon Petroleum Company LP, Findlay, OH (US)

(21) Appl. No.: 14/640,375

(22) Filed: Mar. 6, 2015

Related U.S. Application Data
(60) Provisional application No. 61/949,636, filed on Mar. 7, 2014.

(51) Int. Cl. F16G 11/12

(52) U.S. Cl. CPC F16G 11/12

(57) ABSTRACT

This end fitting is for use with a ratcheting anchoring turnbuckle for expanding or contracting the distance between workpieces. The end fitting comprises a pair of stabilizer bars and a cable swivel wherein the cable swivel is located between the stabilizer bars.

### CROSS REFERENCE TO RELATED APPLICATION

The present patent application claims the benefit of U.S. provisional patent application No. 61/949,636 filed Mar. 7, 2014.

### FIELD OF THE INVENTION

This invention relates to an end fitting for a ratchet turnbuckle. More specifically, the turnbuckle is intended for use with cables to securely tie a plurality of barges together for transport via a tugboat.

### BACKGROUND OF THE INVENTION

A ratchet turnbuckle is comprised of a sleeve which is internally threaded in opposite directions and equipped with a ratchet and a handle. Opposing threaded rods having opposing thread patterns are secured or threaded into the opposed internal threads of the sleeve such that when the sleeve is rotated, the two threaded rods are drawn toward each other. Ratchet turnbuckles have countless applications and are applied in many different industries, however, the present invention is directed towards marine applications including but not limited to securing multiple barges together. A ratchet turnbuckle is used in conjunction with a wire rope or cable to draw large barges together and hold them in place. As the steamboat ratchet is rotated the cable has a tendency to twist, creating a dangerous force, commonly upwards of 5-7 tons, that can cause the turnbuckle to suddenly spin, putting the user at risk.

A metal rod referred to in the industry as a “toothpick” has often been used in an attempt to stabilize the turnbuckle ratchet. However, these “toothpicks” are unstable and may work, loose, thus allowing the turnbuckle to dangerously flip.

### SUMMARY OF THE INVENTION

A new end fitting for use with a ratchet turnbuckle has been designed to specifically prevent flipping or turning of the turnbuckle while under pressure. The new designed end fitting of the present invention provides a threaded end cap having a swivel unit with two stabilizer bars radially extending outwardly from the end cap. The end caps are fixed to the opposed threaded rods of the turnbuckle. The swivel and stabilizer bars allow the wire rope to stay stationary while the turnbuckle is rotated. As pressure is applied to the ratchet turnbuckle and the threaded rods are drawn inward the stabilizer bars of the swivel end fittings rest on the surface of the barge and prevent forces application turning the ratchet turnbuckle from translating to the cable.

### IN THE DRAWINGS

FIG. 1 is a top view of a ratchet, anchoring turnbuckle with the swivel end fittings of the present invention attached to distal ends of the threaded rods of the turnbuckle.

FIG. 2 is an end view of a swivel end fitting as used in FIG. 1.

### DETAILED DESCRIPTION OF THE INVENTION

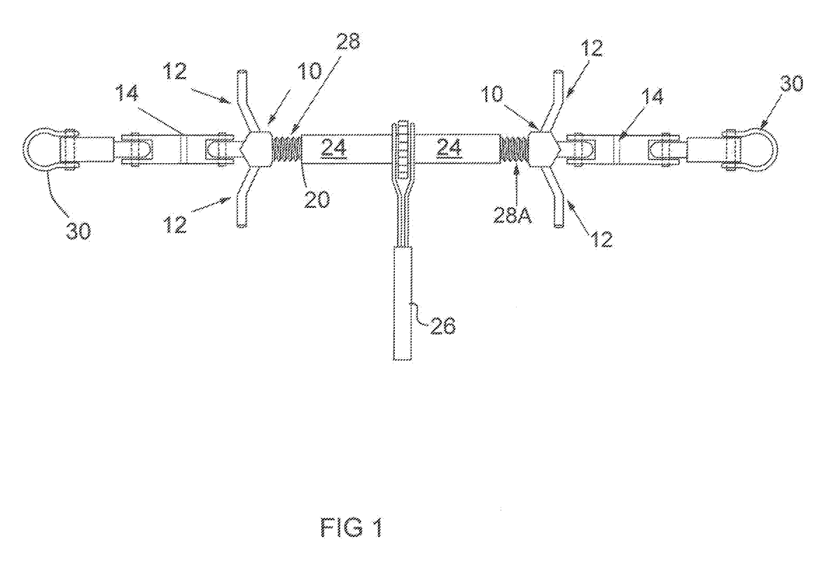

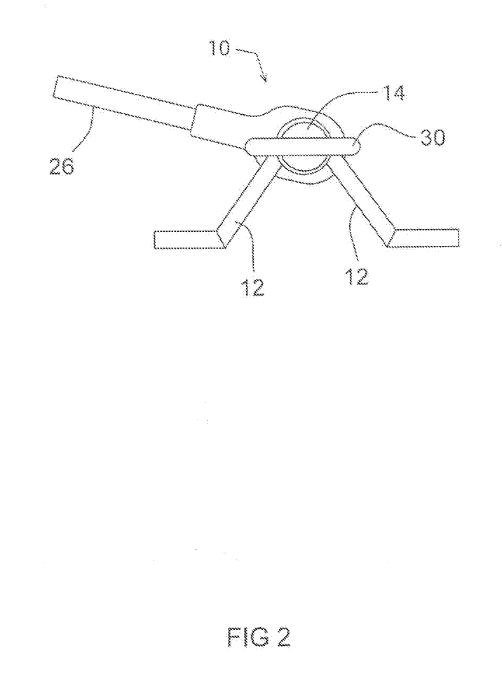

Referring now to FIGS. 1-2, the swivel end fitting 10 of this invention is shown positioned at opposed ends of a turnbuckle 22. Preferably the turnbuckle is a steamboat ratchet turnbuckle. End fitting 10 comprises a pair of stabilizer bars 12 and a cable swivel 14. Preferably, stabilizer bars 12 are legs configured to prevent the twisting force applied to a turnbuckle ratchet from translating to and twisting the attached cables.

A pair of swivel end fittings 10 are attached to distal ends 20 of ratchet, turnbuckle 22. Turnbuckle 22 comprises: cylindrical body 24 having interior threads (not shown); ratchet 26; a first threaded rod 28 having threads disposed in one direction is threaded into turnbuckle 24; a second threaded rod 28A having threads disposed in an opposed direction to the first threaded rod 28 is thread into the opposite end of the turnbuckle 24. The rotation of cylindrical body 24 by ratchet 26 will expand or contract the distance between the workpieces. The swivel end fittings 10 will prevent the translation of rotational forces imparted on the turnbuckle 22 to the attached cables.

The above detailed description of the present invention is given for explanatory purposes. It will be apparent to those skilled in the art that numerous changes and modifications can be made without departing from the scope of the invention. Accordingly, the whole of the foregoing description is to be construed in an illustrative and not a limitative sense, the scope of the invention being defined solely by the appended claims.

1-8. (canceled)

9. An and fitting for use with a turnbuckle having opposed threaded rods located at the distal ends of the turnbuckle, the turnbuckle intended for attachment to a cable engaged with work pieces, wherein upon operation of the turnbuckle the opposed threaded rods expand and contract to apply force to the cable to expand or contract the distance between the work pieces;
the end fitting being configured to engage with at least one of the threaded rods, and including at least one swivel unit configured to engage with the cable, and a pair of stabilizer legs positioned on the end fitting for engagement with a support surface, whereby upon rotational operation of the turnbuckle the swivel unit and the pair of stabilizer legs engage the support surface and absorb rotational forces and prevent those forces from being imparted to the cable.

10-11. (canceled)

12. End fittings for use with a turnbuckle having opposed threaded rods located at the distal ends of the turnbuckle, the turnbuckle intended for attachment to cables engaged with work pieces, wherein upon operation of the turnbuckle the opposed threaded rods expand and contract to apply forces to the cables to expand or contract the distance between the work pieces;
the end fittings being configured to engage with the distal ends of the opposed threaded rods, each end fitting including a swivel unit configured to engage with a respective cable, a pair of stabilizer legs positioned on each respective end fitting for engagement with a support surface, whereby upon rotational operation of the turnbuckle, the swivel units and the respective pairs of stabilizer legs engage the support surface and absorb rotational forces, thereby preventing those forces by feeing imparted to the cables.
